(19) United States
(12) Patent Application Publication
(10) Pub. No.: US 2022/0015335 A1
(43) Pub. Date: Jan. 20, 2022

(54) AUXILIARY ANT MOAT FOR HUMMINGBIRD FEEDER AND METHOD OF USE THEREOF

(71) Applicant: Woodstream Corporation, Lititz, PA (US)

(72) Inventors: Steven Charles LORRAINE, Glastonbury, CT (US); Luke Benjamin HANEY, Lititz, PA (US)

(73) Assignee: Woodstream Corporation, Lititz, PA (US)

(21) Appl. No.: 16/930,459

(22) Filed: Jul. 16, 2020

(51) Int. Cl. A01K 39/02; A01M 29/34; G09F 23/00

(52) U.S. Cl. CPC A01K 39/0206; A01M 29/34; G09F 2023/0025; A01M 2200/011; G09F 23/00

(57) ABSTRACT

An ant moat for use with a hummingbird feeder and an ant-resistant hummingbird assembly are provided. The ant moat includes a reservoir body having a base and at least one sidewall that together define a cup or container having a fluid holding region with an open top. The sidewall of the reservoir body includes a water level indicator and an oil level indicator that is positioned above the water level indicator. In use, water is added to the reservoir body up to the water level indicator, and then a layer of oil is added, on top of the water, up to the oil level indicator. The oil acts to prevent the water from evaporating which extends the time period over which the moat can effectively prevent ants from reaching the nectar access apertures in the hummingbird feeder.

### BACKGROUND OF THE INVENTION

### Field of the Invention

The present invention is related to the field of bird feeders and, more particularly, to an improved ant moat and method of use thereof with a hummingbird feeder, and to an ant-resistant hummingbird feeder assembly.

### Description of the Related Art

People who live in an area inhabited by hummingbirds frequently try to promote their presence by the use of hummingbird feeders. Hummingbird feeders differ from ordinary bird feeders because hummingbirds feed on a sugar-based nectar or simulated nectar, which is liquid, instead of the dry food consumed by most birds. In many hummingbird feeders, the nectar (or simulated nectar) is stored in a reservoir and conveyed to artificial flowers where a perch may be provided so that the hummingbird can land and, having a long, slender beak, insert the same into the access aperture provided in each of the simulated flowers and extract liquid nectar therefrom.

Unfortunately, because the nectar or nectar-like liquids stored in the feeder are sweet, ants are also attracted to the hummingbird feeder. Since the feeder must be supported when in use, typically being hung by a hanger wire that extends down to the top of the feeder from a support element, the ants are able to crawl onto the support element, down the hanger wire onto the top of the feeder, and then down the sides thereof to reach the access apertures. The ants thereby not only consume the nectar but enter the feeder reservoir, typically en masse. Once inside the base of the reservoir, the ants drown, creating a very unpleasant situation for the consumer who must clean out the feeder before it can be refilled with fresh nectar.

To prevent the ants from reaching the nectar access apertures, ant moats have been developed that are positioned above the feeder. Such ant moats are typically formed to have a water-holding region with an open top that surrounds a hook in the center. The hook couples the moat to the hanger wire while the handle of the feeder is connected to another hook on the bottom of the ant moat. After climbing down the hanger wire, the ants are blocked from further progress as they are unable to navigate their way across the water in the moat.

The effectiveness of the moat is, however, dependent upon the presence of water therein. In hot climates, the moat may run dry fairly rapidly, leaving the feeder vulnerable to an ant invasion until the moat is again filled with water.

Accordingly, a need exists for an ant moat that can block ant access to the nectar apertures of a hummingbird feeder with longer-lasting effectiveness.

### SUMMARY OF THE INVENTION

In view of the foregoing, the present invention is directed to an improved ant moat and method of use thereof with a hummingbird feeder, and to an ant-resistant hummingbird feeder assembly. The ant moat includes a reservoir body having an open-top configuration with a base and at least one sidewall that together define a cup or container that holds fluid while the upper surface of the fluid is exposed at the open top. The reservoir body is suspended by a connecting element that projects upwardly from within the base of the body to be coupled to a hanger wire, and further includes a bottom, downwardly directed connecting element for coupling to the handle or other hanging element of a hummingbird feeder. The sidewall of the reservoir body, which is preferably transparent, is provided with a water level indicator and an oil level indicator that is positioned above the water level indicator.

The water level indicator and the oil level indicator are each preferably embodied as a horizontal line accompanied by an appropriate symbol or word designation. According to a preferred embodiment, the water level indicator includes a first line and the word “WATER” associated therewith, while the oil level indicator includes a second line and the word “OIL” associated therewith. The first and second lines are preferably horizontal in orientation and preferably parallel with one another when the ant moat is in use. The water and oil level indicators may alternatively be embodied as two horizontal lines vertically spaced from one another, but without accompanying word or symbol designators. However, inclusion of the word designations and/or symbols next to their respective lines is preferred with the understanding that the words may be modified as appropriate for use in different languages. The water and oil level indicators may be molded into the sidewall, printed on the sidewall, or the like.

The sidewall may be curved or may include a plurality of flat portions to form a truncated pyramid having at least three sides or other three-dimensional geometric shape having multiple planar sides, such as six-sided. In the case of multiple sides, the water and oil level indicators may be placed on any number of the sides including only one of the sides.

In use, the fluid holding region of the ant moat defined by the cup or container is filled with water up to the water level indicator line. Subsequently, a layer of oil, preferably mineral oil, is added to bring the total fluid level in the reservoir body up to the oil level indicator line. The layer of oil, being less dense than and insoluble with water, remains on top of the water, insulating the water from exposure to the air and preventing evaporation. To work effectively in preventing evaporation, this oil layer need only form a thin film such as 3/16th inch but can be up to about ⅛th inch deep if desired, with the greater thickness of the layer serving to lengthen the time period over which protection against evaporation is provided. By protecting the water from evaporation, the oil increases the longevity of the water to greatly extend the time period over which the moat can effectively prevent ants from reaching the access openings at the base of the hummingbird feeder, as compared with conventional moats containing only water.

Accordingly, it is an object of the present invention to provide an improved ant moat for use with a hummingbird feeder, the ant moat including a reservoir body having an open-top configuration with a base and at least one sidewall that define a fluid holding cup or container, and having top and bottom connecting elements, such as hooks, respectively used to suspend the ant moat from a hanger wire and support a hummingbird feeder beneath the ant moat, the sidewall of the reservoir body being provided with a water level indicator and an oil level indicator that is positioned above the water level indicator.

Another object of the present invention is to provide an improved ant moat in accordance with the preceding object in which the water level indicator includes a first horizontal line representing the water level indicator line and the oil level indicator includes a second horizontal line representing the oil level indicator line, the second horizontal line being vertically spaced above and parallel with the first horizontal line, the first and second horizontal lines being molded into, printed on, or otherwise affixed to the sidewall.

Yet another object of the present invention is to provide a method of using the improved ant moat according to the preceding object that includes filling the ant moat reservoir with water up to the water level indicator line and then adding a layer of oil on top of the water to bring the total fluid level in the reservoir body up to the oil level indicator line, the oil insulating the water from exposure to the air and thus acting to protect the water from evaporation.

A further object of the present invention is to provide an improved ant moat in accordance with the preceding object in which the water level indicator further includes a word designation, preferably “WATER”, associated with the first horizontal line and the oil level indicator further includes a different word designation, preferably “OIL”, associated with the second horizontal line, the word designations being molded into, printed on, or otherwise affixed to the sidewall.

Yet a further object of the present invention is to provide an improved ant moat and method of use in accordance with at least one of the preceding objects in which the side wall of the reservoir is transparent.

A still further object of the present invention is to provide an improved ant moat and method of use in accordance with at least one of the preceding objects in which the side wall is formed of a plurality of planar sides joined to form a truncated pyramid having at least three sides.

Another object of the present invention is to provide an improved ant moat and method of use in accordance with the preceding object in which the water and oil level indicators are provided on only one of the plurality of planar sides.

Yet another object of the present invention is to provide an improved ant moat and method of use in accordance with at least one of the preceding objects in which the depth of the layer of oil added on top of the water is between that of a film, as needed to form a thin surface coat, to about ⅛″ thick.

A further object of the present invention is to provide an improved ant moat and method of use in accordance with at least one of the preceding objects in which the oil is mineral oil.

A still further object of the present invention is to provide an improved ant moat and method of use in accordance with at least one of the preceding objects that is easy and cost-effective to use, readily manufactured and durable in operation.

Another object of the present invention is to provide an ant-resistant hummingbird feeder assembly that includes a hummingbird feeder and an ant moat supported by a hanger wire, the hummingbird feeder including a nectar reservoir in fluid communication with a bottom basin having nectar access apertures, the ant moat including a reservoir body with a base and sidewall that together define a cup or container having an open top for holding fluid while the upper surface of the fluid is exposed, the reservoir body including a bottom connecting element for attachment to the upper end of the feeder and a top connecting element that is coupled to the hanger wire, the sidewall of the reservoir body of the ant moat including a water level indicator and an oil level indicator spaced above the water level indicator.

Yet another object of the present invention is to provide an ant-resistant hummingbird feeder assembly in accordance with preceding object in which the water level indicator includes a first horizontal line and the oil level indicator includes a second horizontal line, the second horizontal line being parallel with the first horizontal line, the first and second horizontal lines being molded into, printed on, or otherwise affixed to the sidewall.

Still another object of the present invention is to provide an ant-resistant hummingbird feeder assembly in accordance with the preceding object in which the water level indicator further includes a word designation, preferably “WATER”, associated with the first horizontal line and the oil level indicator further includes a different word designation, preferably “OIL”, associated with the second horizontal line, the word designations being molded into, printed on, or otherwise affixed to the sidewall.

These together with other objects and advantages which will become subsequently apparent reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a side perspective view of an ant-resistant hummingbird feeder assembly including an ant moat coupled to a hanger wire and supporting a hummingbird feeder in accordance with the present invention.

FIG. 2 is a side perspective view of the ant moat shown in FIG. 1, in isolation.

FIG. 3 is a side perspective view of an ant moat like that shown in FIG. 2, but having transparent sidewalls.

FIG. 3A is an enlarged view of Detail A of FIG. 3.

FIG. 4A shows the first step of adding water to the ant moat in accordance with the method of use of the present invention.

FIG. 4B shows the second step of adding oil on top of the water in the ant moat following the first step shown in FIG. 4A.

### DETAILED DESCRIPTION OF THE PREFERRED EMBODIMENTS

It is to be understood that the embodiments described herein are disclosed by way of illustration only. It is not intended that the invention be limited in its scope to the details of construction and arrangement of components set forth in the following description or illustrated in the drawings. Also, in describing the preferred embodiments, specific terminology will be resorted to for the sake of clarity. It is to be understood that each specific term includes all technical equivalents which operate in a similar manner to accomplish a similar purpose.

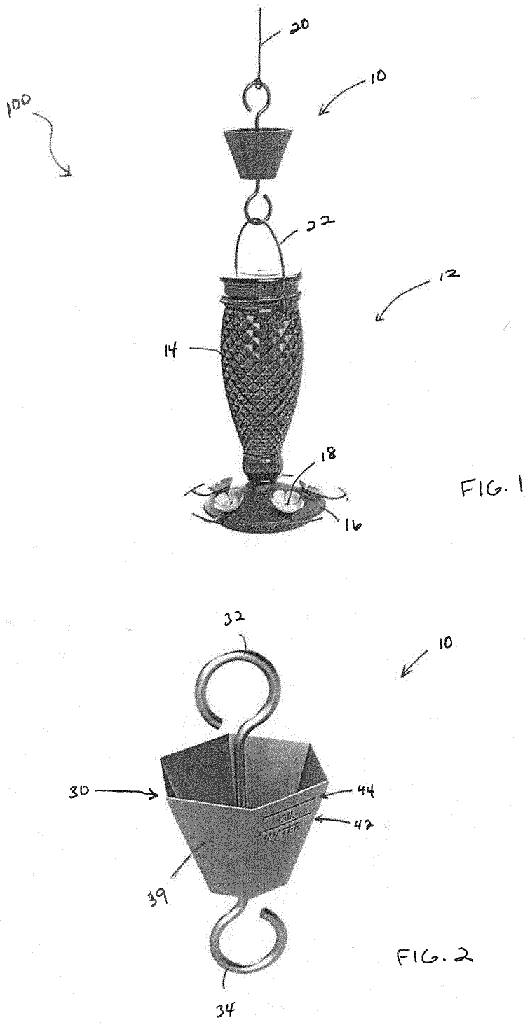

As shown in FIG. 1, the present invention is directed to an ant-resistance hummingbird feeder assembly generally designated by reference numeral 100, the assembly including an ant moat generally designated by reference numeral 10 and a hummingbird feeder generally designated by reference numeral 12. Within the assembly 100, the hummingbird feeder 12 may be of any number of various designs but generally includes a nectar reservoir 14 in fluid communication with a bottom basin 16 having nectar access apertures 18 through which a hummingbird can insert its beak to access nectar held within the basin. The feeder 12 is typically suspended from a support element (not shown) by a hanger wire 20 that is coupled to a handle 22 or other structural feature of the feeder.

As shown in the assembly 100 of FIG. 1, rather than coupling the handle 22 directly to the hanger wire 20 to hang the feeder 12, the ant moat 10 according to the present invention is coupled between the hanger wire 20 and the handle 22. In this position, the ant moat can effectively block ants that travel down the hanger wire 20 from reaching the access apertures 18 as will be further explained hereinafter.

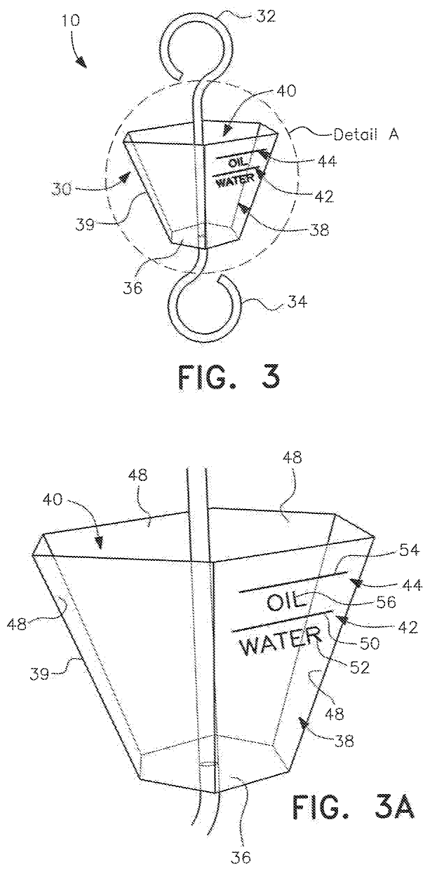

As shown in isolation in FIGS. 2 and 3, the ant moat 10 includes a reservoir body generally designated by reference numeral 30, a top connecting element 32, and a bottom connecting element 34. The top connecting element 32, which as shown is embodied as a hook that projects upwardly and extends above the reservoir body, is used to couple the ant moat 10 to the hanger wire 20, while the feeder 12 is suspended from the bottom connecting element 34, also embodied as a hook, that extends downwardly (see FIG. 1).

Alternatively, the top connecting element 32 may be embodied as a boss having an aperture therein to which the hanger wire is connected. In such a configuration, the lower end of the hanger wire would be under the fluid level held in the reservoir body when the ant moat is filled with fluid. Similarly, the bottom connecting element 34 may also be embodied as a boss or other structure having an aperture through which a separate hook element, such as a piece of bent wire or the like, could be hooked and then secured at an opposing end thereof to the handle of the feeder 12. However, connecting elements formed as hooks as shown herein are preferred.

The reservoir body 30 includes a base 36 (see FIG. 3A) and at least one sidewall generally designated by reference numeral 38. The base 36 and the sidewall 38 together form a cup or container 39 which defines a fluid holding region generally designated by reference numeral 40 which is open at the top so that an upper surface of the fluid held in the cup or container 39 is exposed. The top and bottom connecting elements 32, 34 are mounted on the base 36 and may be formed to be integral with the reservoir body. The portion of the top connecting element inside the cup or container is spaced from the sidewall 38 so that fluid held in the region 40 blocks ants that may be crawling on the upper end of the top connecting element from accessing the sidewall.

The sidewall of the reservoir body is provided with a water level indicator generally designated by reference numeral 42 and an oil level indicator generally designated by reference numeral 44. The oil level indicator is positioned above the water level indicator relative to the base 36. As shown in FIGS. 3 and 3A, the sidewall of the reservoir body is preferably transparent.

The sidewall may be curved (not shown) or may include a plurality of flat portions to form a truncated pyramid having at least three sides. According to the embodiment shown, the reservoir body is a tapered, truncated hexagonal polygon having six planar sides 48. However, the sidewall may be formed to have any number of three-dimensional geometric shapes having multiple planar sides. In the case of multiple sides, the water and oil level indicators may be placed on any number of the sides including, as shown in FIGS. 2, 3 and 3A, on only one of the sides.

As best seen in FIG. 3A, the water level indicator 42 is preferably embodied to include a first horizontal line 50 accompanied by an appropriate symbol or word designation 52. In like manner, the oil level indicator 44 is preferably embodied to include a second horizontal line 54 accompanied by an appropriate symbol or word designation 56. According to a preferred embodiment, the symbol or word designation 52 associated with the first horizontal line 50 is the word “WATER”, while the symbol or word designation 56 associated with the second horizontal line 54 is the word “OIL”.

The first and second horizontal lines 50, 54 are parallel with one another and horizontal in orientation when the ant moat 10 is in use. The water and oil level indicators may alternatively be embodied as two horizontal lines vertically spaced from one another, but without accompanying word or symbol designations. However, inclusion of the word designations next to their respective lines is preferred with the understanding that the words may be modified as appropriate for use in different languages.

The water and oil level indicators may be molded into the sidewall, printed on the sidewall, or the like. The horizontal lines and word designations are preferably raised and/or indented to provide a tactile sensation and also for enhanced visual clarity.

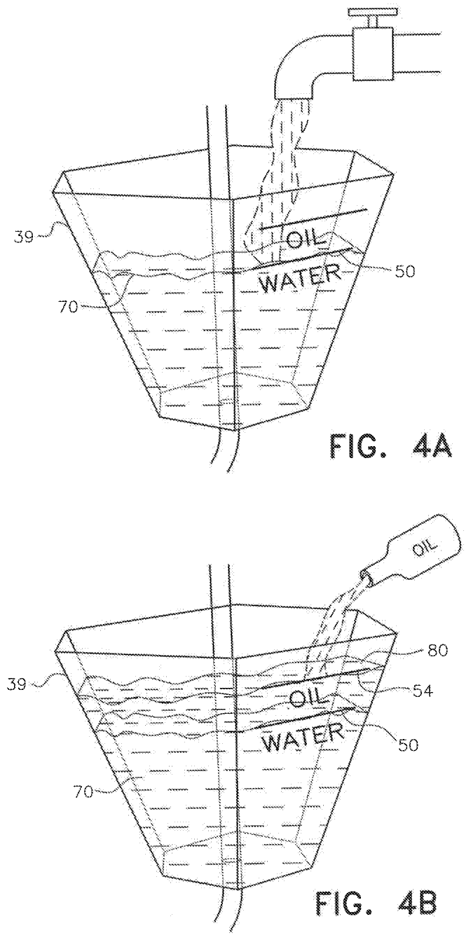

In use, the fluid holding region 40 of the cup or container 39 of the ant moat 10 is filled with water 70 up to the water level indicator line 50 as shown in FIG. 4A. Subsequently, a layer of oil 80 is added to bring the total fluid level in the reservoir body up to the oil level indicator line 54, with the top connecting element 32 projecting upwardly from underneath the liquid level in the fluid holding region 40 as shown in FIG. 4B. The layer of oil, being less dense than and insoluble with water, remains on top of the water, insulating the water from exposure to the air and preventing evaporation. The oil is preferably mineral oil as mineral oil is not a food derivative and will not spoil or rot which could cause an unpleasant odor. Other oils which are stable, less dense than water and do not present unpleasant odors can be used in accordance with the present invention.

To work effectively in preventing evaporation, the oil layer need only form a thin film but can be up to ⅛th inch deep if desired. By protecting the water from evaporation, the oil increases the longevity of the water to greatly extend the time period over which the moat can effectively prevent ants from reaching the access openings at the base of the hummingbird feeder, as compared with conventional moats containing only water.

The improved ant moat and method of use according to the present invention is easy and cost-effective to use, readily manufactured and durable in operation.

The water and oil level indicators are not intended to be limited to horizontal lines but may be any indicia suitable for marking a desired level for fluid(s). For example, the indicators could be vertical lines, the upper extent of which marks the fluid level, or could be one or more dots, raised or indented, of varying shapes that can be used to indicate a fluid level.

Accordingly, the foregoing descriptions and drawings should be considered as illustrative only and the invention may be configured in a variety of shapes and sizes and is not limited to the shape of the preferred embodiment. Therefore, it is not desired to limit the invention to the specific examples disclosed or the exact construction and operation shown and described. Rather, all suitable modifications and equivalents may be resorted to, falling within the scope of the invention.

What is claimed is:

1. An ant moat for use with a hummingbird feeder, said ant moat comprising a reservoir body including a base and at least one sidewall that together define a fluid holding region having an open top, said reservoir body including a top connecting element that projects upwardly from the base underneath the liquid level in the fluid holding region to be coupled to a hanger wire, and a bottom connecting element that is directed downwardly from the base for connection to a hummingbird feeder that is supported beneath the ant moat, the sidewall of the reservoir body including a water level indicator and an oil level indicator that is positioned above the water level indicator.

2. The ant moat as set forth in claim 1, wherein the sidewall is transparent.

3. The ant moat as set forth in claim 1, wherein the sidewall is formed of a plurality of planar sides to form a three-dimensional polygon, the water level indicator and the oil level indicator being provided on at least one of said plurality of planar sides.

4. The ant moat as set forth in claim 3, wherein the three-dimensional polygon has six planar sides to be hexagonal.

5. The ant moat as set forth in claim 4, wherein the water level indicator and the oil level indicator are provided on only one of said six planar sides.

6. The ant moat as set forth in claim 3, wherein the water level indicator includes a first horizontal line and the oil level indicator includes a second horizontal line, said second horizontal line being spaced above and parallel with said first horizontal line.

7. The ant moat as set forth in claim 6, wherein the water level indicator further includes a first word designation associated with the first horizontal line and the oil level indicator includes a second word designation associated with the second horizontal line.

8. The ant moat as set forth in claim 7, wherein the first word designation is “WATER” and the second word designation is “OIL”.

9. A method of using an ant moat with a hummingbird feeder having one or more nectar access apertures, the ant moat including a reservoir body including a base and at least one sidewall that together define a fluid holding region having an open top, said reservoir body including a bottom connecting element that is directed downwardly from the base for connection to the hummingbird feeder that is supported beneath the ant moat, and a top connecting element that projects upwardly from the base of the body to be coupled to a hanger wire that is used to support the ant moat and the hummingbird feeder from a support element, the sidewall of the reservoir body including a water level indicator and an oil level indicator that is positioned above the water level indicator, the method comprising:
securing the top connecting element of the ant moat to the hanger wire with the hummingbird feeder coupled to the bottom hook element prior to use;
adding water to the fluid holding region up to the water level indicator;
adding oil to the fluid holding region up to the oil level indicator, the oil remaining on top of the water to prevent the water from evaporating when the feeder is in use and thereby extending the time period over which the ant moat is effective in preventing ants from reaching the nectar access apertures in the hummingbird feeder.

10. The method as set forth in claim 9, wherein the oil is mineral oil.

11. An ant-resistant hummingbird feeder assembly comprising:
a hummingbird feeder including a nectar reservoir in fluid communication with a bottom basin, said bottom basin having nectar access apertures through which a hummingbird can insert its beak to access nectar held within the basin, an upper end of said nectar reservoir having a hanging structure used to support the feeder in a vertically suspended configuration; and
an ant moat including a reservoir body having a base and at least one sidewall that together define a fluid holding region having an open top, said reservoir body including a bottom connecting element that is directed downwardly from the base for attachment to the hanging structure of the hummingbird feeder that is supported beneath the ant moat, and a top connecting element that projects upwardly from the base of the body to be coupled to a hanger wire that is used to support the ant moat and the hummingbird feeder from a support element in the vertically suspended configuration, the sidewall of the reservoir body of the ant moat including a water level indicator and an oil level indicator that is positioned above the water level indicator.

12. The ant-resistant hummingbird feeder assembly as set forth in claim 11, wherein the hanging structure of the hummingbird feeder is a handle.

13. The ant-resistant hummingbird feeder assembly as set forth in claim 11, wherein the top and bottom connecting elements are hook elements.

14. The ant-resistant hummingbird feeder assembly as set forth in claim 11, wherein the sidewall of the ant moat is transparent.

15. The ant-resistant hummingbird feeder assembly as set forth in claim 11, wherein the sidewall is formed of a plurality of planar sides to form a three-dimensional polygon, the water level indicator and the oil level indicator being provided on at least one of said plurality of planar sides.

16. The ant-resistant hummingbird feeder assembly as set forth in claim 15, wherein the water level indicator and the oil level indicator are provided on only one of said plurality of planar sides.

17. The ant-resistant hummingbird feeder assembly as set forth in claim 15, wherein the water level indicator includes a first horizontal line and the oil level indicator includes a second horizontal line, said second horizontal line being spaced above and parallel with said first horizontal line.

18. The ant-resistant hummingbird feeder assembly as set forth in claim 17, wherein the water level indicator further includes a first word designation associated with the first horizontal line and the oil level indicator includes a second word designation associated with the second horizontal line.

19. The ant-resistant hummingbird feeder assembly as set forth in claim 18, wherein the first word designation is “WATER” and the second word designation is “OIL”.
